(19) United States
(12) Patent Application Publication
(10) Pub. No.: US 2025/0122801 A1
(43) Pub. Date: Apr. 17, 2025

(54) METHOD OF MEASURING RHEOLOGY OF A FLUID USING TESLA TURBINE PRINCIPLE

(71) Applicant: Baker Hughes Oilfield Operations LLC, Houston, TX (US)

(72) Inventors: Charles A. Thompson, JR., Kingwood, TX (US); Aswath Krishnan, Spring, TX (US); Syed Ehsanur Rahman, Houston, TX (US); Reza Ettehadi Osgouei, Houston, TX (US); Jose Martinez, Spring, TX (US); Nils Kaageson-Loe, Claremore, OK (US)

(21) Appl. No.: 18/905,579

(22) Filed: Oct. 3, 2024

Related U.S. Application Data
(60) Provisional application No. 63/589,713, filed on Oct. 12, 2023.

(51) Int. Cl. E21B 49/08; G01N 11/08

(52) U.S. Cl. CPC E21B 49/0875; G01N 11/08

(57) ABSTRACT

A system and method of determining a rheological property of a fluid. A turbine has at least two disks separated by a variable gap and rotating around a rotational axis of the turbine. Fluid flows into the gap at a circumferential edge of the disks to rotate the disks. A first value of a dynamic parameter of the turbine resulting from an interaction between the disks and the fluid in the gap is measured as the fluid flows from the circumferential edge towards the axis with the gap having a first gap width. A second value of the dynamic parameter is measured with the gap having a second gap width different from the first gap width. The rheological property of the fluid is determined based on the first value of the dynamic parameter and the second value of the dynamic parameter.

This application claims the benefit of an earlier filing date from U.S. Provisional Application Ser. No. 63/589,713, filed Oct. 12, 2023, the entire disclosure of which is incorporated herein by reference.

### BACKGROUND

In the resource recovery and fluid sequestration industries, a drill string is extended into a borehole to drill the borehole. Drilling the borehole results in cuttings. Drilling fluid flows downhole through the drill string and out of the drill string at a bottom end. The drilling fluid then flows uphole in an annulus formed by the drill string and a wall of the borehole to retrieve cuttings from the borehole. The rheological properties of the drilling fluid is a factor in the effectiveness of the drilling fluid. Therefore, there is a need to be able to determine the rheological properties prior to use of the drilling fluid in the borehole.

### SUMMARY

Disclosed herein is a method of determining a rheological property of a fluid. Fluid is flowed into a turbine having at least two disks that are rotatable about a rotational axis and having a gap therebetween. The fluid flows into the gap at a circumferential edge of the at least two disks to rotate the at least two disks around the rotational axis. The gap is variable. A first value of a dynamic parameter of the turbine resulting from an interaction between the at least two disks and the fluid in the gap is measured as the fluid flows from the circumferential edge towards the axis with the gap having a first gap width. A second value of the dynamic parameter is measured with the gap having a second gap width different from the first gap width. The rheological property of the fluid is determined based on the first value of the dynamic parameter and the second value of the dynamic parameter.

Also disclosed herein is a system for measuring a rheological property of a fluid. The system includes a turbine having at least two disks rotating around a rotational axis of the turbine, the at least two disks separated by a gap that is variable, a nozzle at a circumferential edge of the at least two disks for flowing the fluid into the gap, a sensor for measuring a dynamic parameter of the turbine resulting from an interaction between the at least two disks and the fluid in the gap as the fluid flows from the circumferential edge towards the axis, and a processor. The processor is configured to determine the rheological property of the fluid based on a first value of the dynamic parameter of the turbine obtained from the sensor with the gap having a first gap width and a second value obtained from the sensor with the gap having a second gap width different from the first gap width.

Also disclosed is a method of determining a rheological property of a fluid. The fluid flows into a turbine having at least two disks that are rotatable about a rotational axis and having a gap therebetween, wherein the fluid flows into the gap at a circumferential edge of the at least two disks to rotate the at least two disks around the rotational axis. A first value of a dynamic parameter of the turbine resulting from an interaction between the at least two disks and the fluid in the gap is measured as the fluid flows from the circumferential edge towards the axis, wherein the fluid has a first value of the fluid flow parameter. A second value of the dynamic parameter of the turbine resulting from an interaction between the at least two disks and the fluid in the gap is measured as the fluid flows from the circumferential edge towards the axis, wherein the fluid has a second value of the second fluid flow parameter. The rheological property of the fluid is determined based on the first value of the dynamic parameter and the second value of the dynamic parameter.

### BRIEF DESCRIPTION OF THE DRAWINGS

The following descriptions should not be considered limiting in any way. With reference to the accompanying drawings, like elements are numbered alike:

FIG. 1 shows a borehole system in an illustrative embodiment;

FIG. 2 shows a detailed view of the fluid testing device in an illustrative embodiment;

FIG. 3 shows a view of the turbine along the rotational axis;

FIG. 4 shows a diagram of a fluid testing device integrated into a fluid line;

FIG. 5 is a graph showing a relation between a dynamic parameter of the turbine and a gap width between rotating disks of the turbine;

FIG. 6 shows a graph of test results for various fluids;

FIG. 7 shows a diagram of a fluid testing device including a plurality of turbines aligned in parallel along a fluid line, in another embodiment; and

FIG. 8 shows a detailed view of the turbines of FIG. 7 in an embodiment with different gap widths.

### DETAILED DESCRIPTION

A detailed description of one or more embodiments of the disclosed apparatus and method are presented herein by way of exemplification and not limitation with reference to the Figures.

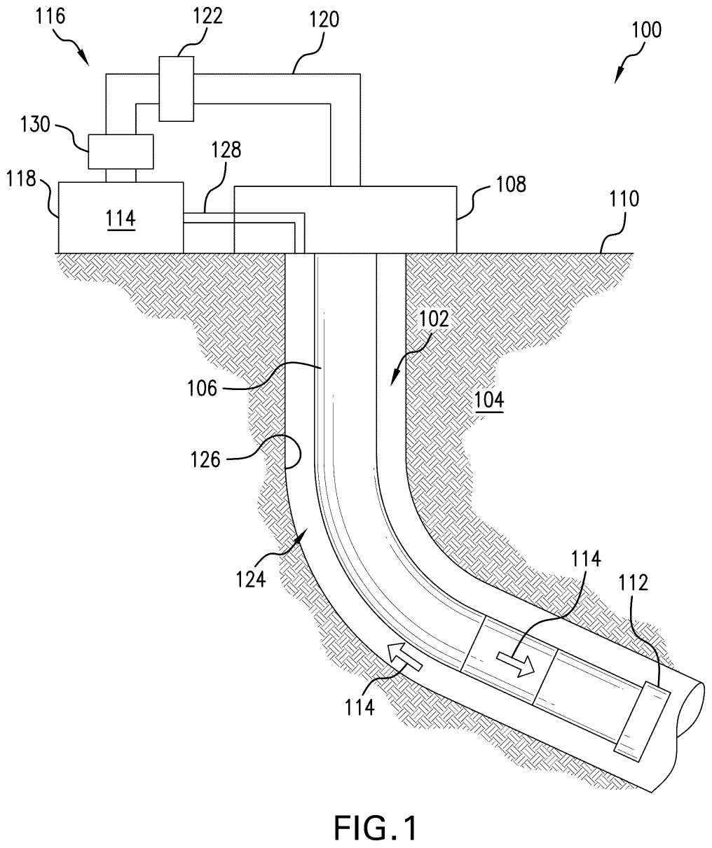

Referring to FIG. 1, a borehole system 100 is illustrated. The borehole system 100 comprises a borehole 102 formed in a subsurface formation 104. A drill string 106 extends from a platform 108 at a surface location 110 into the borehole 102. The drill string 106 includes a drill bit 112 at a bottom end that is used to drill the borehole 102 and which produces cuttings during the drilling operation. A drilling fluid 114 is circulated through the borehole 102 to remove the cuttings from the borehole 102.

A drilling fluid circulation system 116 includes a fluid reservoir 118 that stores the drilling fluid 114 at the surface location 110 and an injection pipe 120 that extends from the fluid reservoir 118 to a top end of the drill string 106. The injection pipe 120 includes a pump 122 for pumping the drilling fluid 114 from the fluid reservoir 118 into the drill string 106. The drilling fluid 114 flow downhole through a central bore of the drill string 106 to exit into the borehole 102 at the drill bit 112. The drilling fluid 114 then flows to the surface through an annulus 124 between the drill string 106 and a wall 126 of the borehole 102. At the surface location 110, the drilling fluid 114 returns to the fluid reservoir 118 via a return pipe 128.

The drill string 106 is an example of a work string suitable for use in the borehole 102. In other embodiments, the methods disclosed herein are not limited to a drill string 106 and can be used with other types of work strings.

A fluid testing device 130 can be located in the injection pipe 120. The fluid testing device 130 can be used to determine a rheological parameter of the drilling fluid. The rheological parameter can be, but is not limited to, a viscosity, a shear rate, a shear stress, and adhesion of the fluid, etc. In another embodiment, the fluid testing device 130 can be located downhole in the drill string 106. Alternatively, the fluid testing device 130 can be at testing location that is independent of the drilling fluid circulation system 116 and can be used to determine the rheological properties prior to the drilling fluid being placed in the fluid reservoir 118.

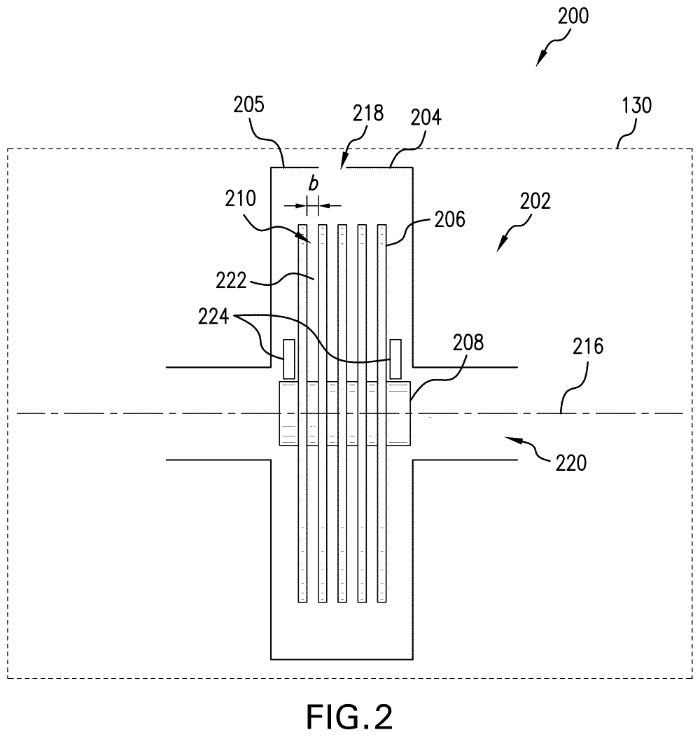

FIG. 2 shows a detailed view 200 of the fluid testing device 130 in an illustrative embodiment. The fluid testing device 130 includes a turbine 202, such as a Tesla turbine. The turbine has a housing 204 that houses at least two disks 206 or plates disposed on a rotor 208. The at least two disks 206 include smooth radially extending surfaces 222. The at least two disks 206 are separated by a gap 210 therebetween having a known gap size or gap width b. The gap can have a fixed gap width or a variable gap width. A gap control device 224 can be used to vary the gap width. The housing 204 has a circumferential surface 205 located at a circumference of the at least two disks 206 and an opening or nozzle 218 at the circumferential surface. The drilling fluid is injected into the housing 204 via the nozzle 218 to enter into the gap 210 between the at least two disks 206 at a circumferential edge of the at least two disks 206. The fluid contacts or interacts with the surfaces of the at least two disks 206, adding energy to the disks as it spirals inward through the gap 210 toward a rotational axis 216 of the rotor 208. As a result of this interaction, the fluid produces a drag at the at least two disks 206 to accelerate the rotation of the at least two disks 206. The amount of acceleration is proportional to a rheological property of the drilling fluid, such as a viscosity of the fluid, a shear rate of the fluid, a shear stress of the fluid, and an adhesion a surface layer of the fluid to the at least two disks 206. The effect of the fluid on operation of the turbine 202 can be used to determine the rheological property of the fluid, as discussed herein. The fluid then flows along the rotational axis 216 to an outlet 220 of the housing 204 to exit the turbine 202. The outlet 220 is along the rotational axis 216. The flow of the fluid through the turbine (i.e., between the at least two disks 206) can be a Newtonian flow or a non-Newtonian flow.

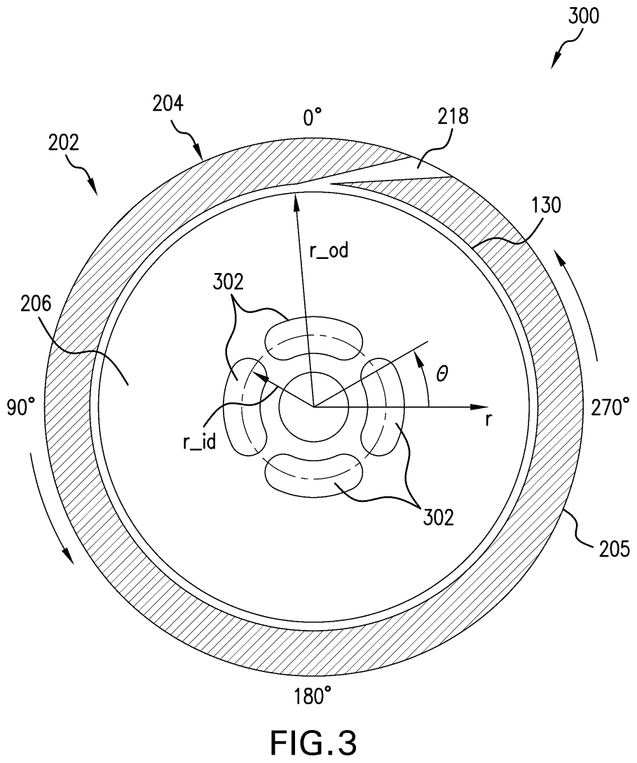

FIG. 3 shows a view 300 of the turbine 202 along the rotational axis 216. The disks 206 have openings 302 located near the center of the disks. The openings 302 allow fluid that is traveling through the gap 210 toward the rotational axis 216 to be diverted to flow parallel to the rotational axis 216 in order to exit the turbine at the outlet 220,

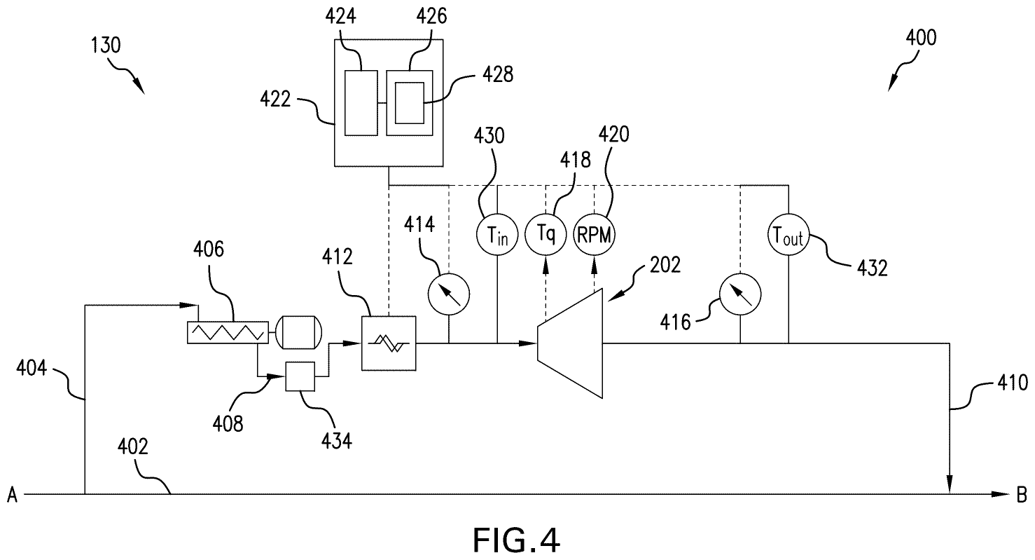

FIG. 4 shows a diagram 400 of a fluid testing device integrated into a fluid line. The fluid flows from point A to point B through a suction line 402. The suction line 402 can be a line through a bore of the drill string and the fluid testing device can be disposed within the drill string. A bleed line 404 extracts a portion of the drilling fluid from the suction line 402. The drilling fluid in the bleed line 404 is input to a pump 406. The pump 406 circulates the fluid through a turbine input line 408 into the turbine 202. Fluid output from the turbine 202 flows back to the suction line 402 via a turbine output line 410. A sensor 412 on the turbine input line 408 measures a flow rate and/or a density of the fluid. The sensor 412 can be a Coriolis meter. A first pressure gauge 414 is located on the turbine input line 408 at an entrance to the turbine 202 and measures a first fluid pressure (i.e., input fluid pressure) at the entrance. In an embodiment, the first pressure gauge 414 is located at the nozzle 218. A first temperature gauge 430 can be located on the turbine input line 408 at the entrance to the turbine 202 to measure a first fluid temperature (i.e., input fluid temperature) at the entrance. A second pressure gauge 416 is located on the turbine output line 410 and measures a second fluid pressure (i.e., output fluid pressure). The second pressure gauge 416 can be located at the outlet 220 of the turbine 202. A second temperature gauge 432 can be located on the turbine output line 410 to measure a second fluid temperature (i.e., output fluid temperature). A torque meter 418 measures a torque on the turbine 202 (e.g., by the motor 212) and a velocity meter 420 measures a rotational velocity of the turbine 202 (e.g., of the disks 206). Fluid flow parameters (i.e., flow rate, fluid density, input fluid pressure, output fluid pressure, input fluid temperature, output fluid temperature) and dynamic parameters of the turbine (i.e., torque, rotational velocity) are measured by the associated sensors and are provided to a controller 422. The controller 422 includes a processor 424 and a computer-readable medium 426, such as a solid-state memory device, having instructions 428 stored thereon. The processor 424 can access and run the instructions 428 to perform a method of determining a rheological property of the fluid based on the various fluid flow parameters and dynamic parameters of the turbine measured by the various sensors. Based on the rheological property, the processor 424 can perform an action at the drilling system, such as changing a chemical composition of the drilling fluid, changing a fluid parameter such as flow rate, fluid pressure, etc., or changing a drilling parameter, such as weight on bit, drilling rotation rate, etc. In an embodiment ion which the fluid testing device is disposed within the drill string, the controller 422 can be located within a bottomhole assembly.

In an embodiment, the processor 424 can determine the rheological property of the fluid by inputting the fluid flow parameters and dynamic parameters of the turbine obtained by the sensors into an equation or mathematical relation that relates them to the rheological property. The mathematical relation can be determined based on previous experiments. In another embodiment, during a previous calibration or laboratory testing operation, the fluid flow parameters and dynamic parameters of the turbine 202 can be measured for drilling fluids having different rheological properties and the measurements can be stored in a database. During the testing operation, the fluid flow parameters and dynamic parameters of the turbine 202 measured by the sensors can be compared to the stored fluid flow parameters and dynamic parameters of the turbine 202 to determine the rheological property. This method can be useful for fluid having non-Newtonian flow.

In an embodiment, a temperature of the fluid flowing through the turbine can be controlled by being either varied or held constant. A temperature control device 434 can be located in the turbine input line 408 to control the temperature of the fluid. The temperature control device 434 can include a water bath, an oil bath, or any other temperature regulating device.

In another embodiment, the rheological property is a gel strength of shear stress of the fluid and the fluid testing device can be used to measure the gel strength. For example, the pump 406 can be stopped in order to stop the flow of fluid in the turbine input line 408. After a selected amount of time, the pump 406 can be restarted so that the flow rate of the fluid increases from a zero-velocity flow rate. The response of the turbine to the increasing flow rate upon restarting the flow of fluid (i.e., the torque and RPM) can be measured to determine the gel strength.

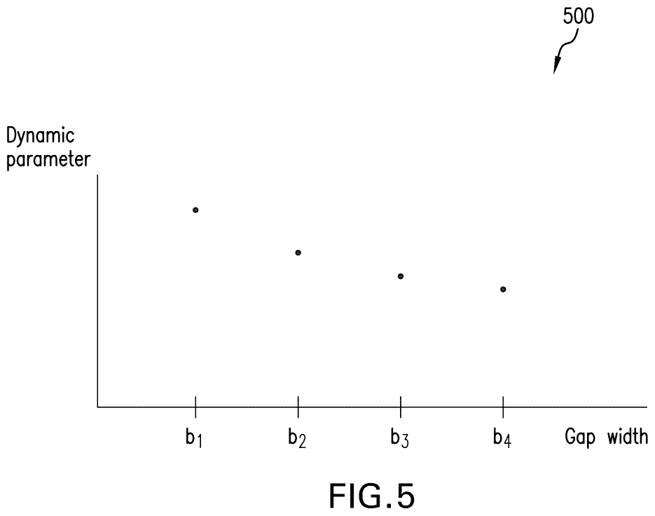

FIG. 5 is a graph 500 showing a relation between a dynamic parameter of the turbine and a gap width between rotating disks of the turbine. The value of the dynamic parameter changes with the gap width. Thus, when the gap is set at a first gap width b₁, the dynamic parameter (e.g., torque, RPM) has a first value P₁ and when the gap is set at a second gap width b₂, the dynamic parameter has a second value P₂, etc. One or more rheological properties can be determined based on the at least a first value and a second value and the associated gap widths. For example, a shear rate can be determined, which can be converted to a shear stress of the fluid. For example, a slope connecting data points can be used to determine the rheological property. Alternatively, a curve can be fit to the data points and the rheological property can be determined using the curve. In operation of the fluid testing device, the gap width can be changed during the fluid testing process (i.e., during continuous flow of the fluid through the turbine) to obtain the data points.

In another embodiment, the rheological property can be determined used a single gap width. Fluid is flowed into the gap having a first value of a fluid flow parameter (first fluid flow parameter value) and a first value of a dynamic parameter of the turbine is measured based on the first value of the flow parameter. Fluid is then flowed into the gap having a second value of the fluid flow parameter (second fluid flow parameter value) and a second value of a dynamic parameter of the turbine is measured based on the second value of the flow parameter. The rheological property of the fluid is determined based on the first value of the flow parameter and the second value of the flow parameter.

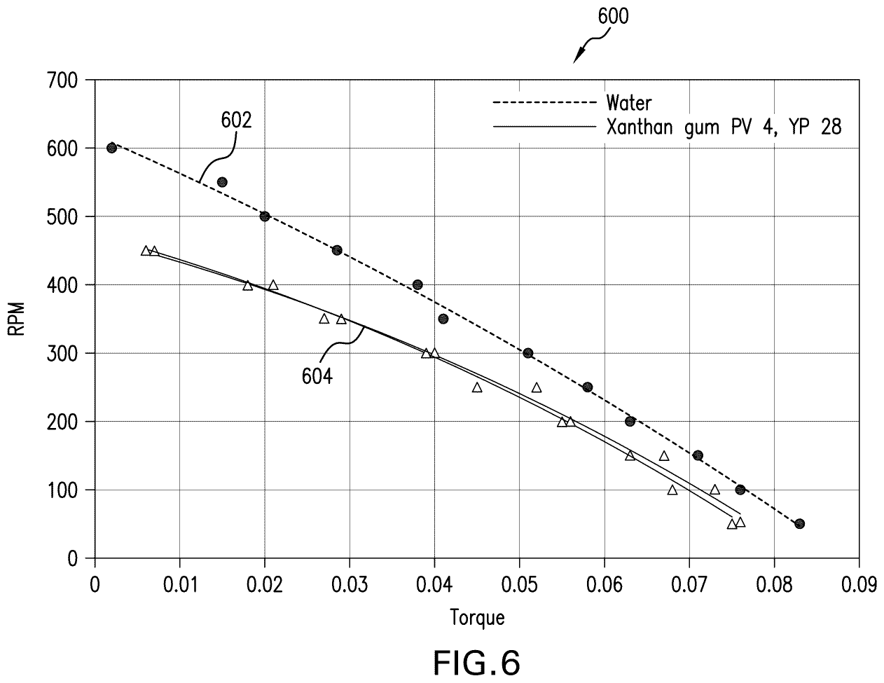

FIG. 6 shows a graph 600 of test results for various fluids. Torque is shown along the abscissa in units of Newton-meters (N-m) and rotational speed of the turbine is shown along the ordinate axis in units of revolutions per minute (RPM). A first curve 602 shows a relation between RPM and torque for water and a second curve 604 shows a relation between RPM and torque for a fluid mixture containing Xanthan gum. Water is a Newtonian fluid, while a fluid mixture containing Xanthan gum is a non-Newtonian fluid. The flow rate for each fluid is held fixed. The first curve 602 shows a linear relation between RPM and torque. The second curve 604 shows a non-linear relation between RPM and torque, which is expected for a non-Newtonian fluid.

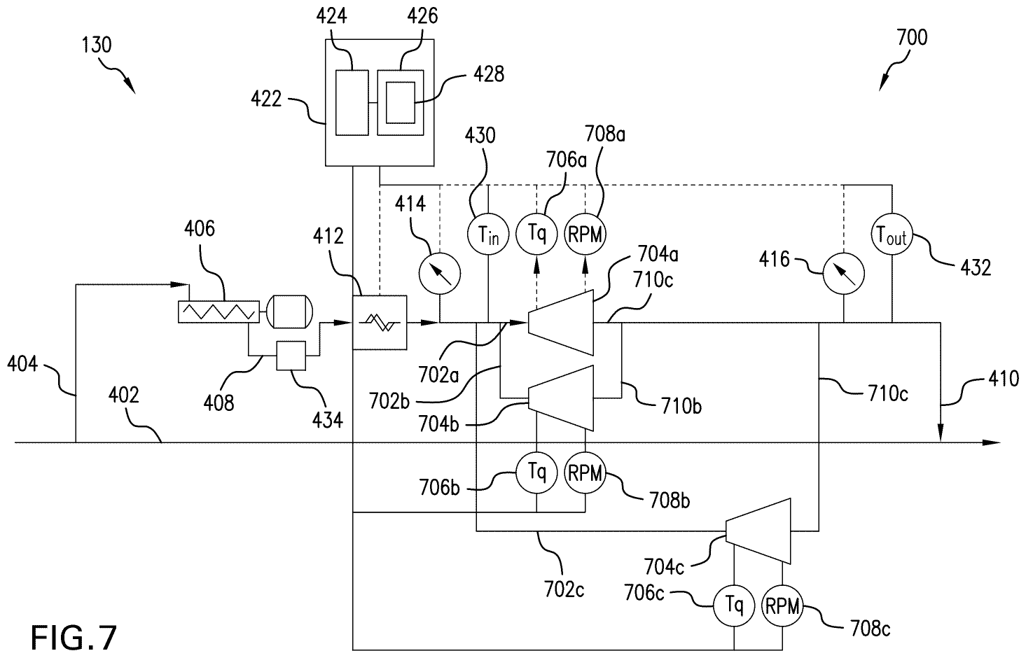

FIG. 7 shows a diagram 700 of a fluid testing device including a plurality of turbines aligned in parallel along a fluid line, in another embodiment. Three turbines are shown for illustrative purposes. However, in various embodiments, any number of turbines can be used. The turbine input line 408 splits into a plurality of branches, shown as a first input branch 702a, a second input branch 702b, and a third input branch 702c. A first turbine 704a is located on and receives fluid via the first input branch 702a. A second turbine 704b is located on and receives fluid via the second input branch 702b. A third turbine 704c is located on and received fluid via the third input branch 702c. A first output branch 710a connects an output of the first turbine 704a to the turbine output line 410. A second output branch 710b connects an output of the second turbine 704b to the turbine output line 410. A third output branch 710c connects an output of the third turbine 704c to the turbine output line 410.

The pump 406 circulates the fluid through turbine input line 408 and thus into the first turbine 704a, second turbine 704b and third turbine 704c, via first input branch 702a, second input branch 702b, and third input branch 702c, respectively. The first pressure gauge 414 and first temperature gauge 430 are located upstream of the split of the turbine input line 408. The second pressure gauge 416 and second temperature gauge 432 are located downstream of the point at which the first output branch 710a. the second output branch 710b, and the third output branch 710c combine into the turbine output line 410. A first torque meter 706a measures a torque on the first turbine 704a and a first velocity meter 708a measures a rotational velocity of the first turbine 704a. A second torque meter 706b measures a torque on the second turbine 704b and a second velocity meter 708b measures a rotational velocity of the second turbine 704b. A third torque meter 706c measures a torque on the third turbine 704c and a third velocity meter 708c measures a rotational velocity of the third turbine 704c. Measurements obtained by these sensors are provided to the controller 422. The controller 422 determines a rheological property of the fluid based on the measurements.

Although three branches are shown for illustrative purposes, the fluid line can split into any number of branches, in various embodiments. Each branch can have one turbine or multiple turbines. The number of turbines on any given branch can be different than the number of turbines on another branch. Each turbine can have its own individual gap width between its disks.

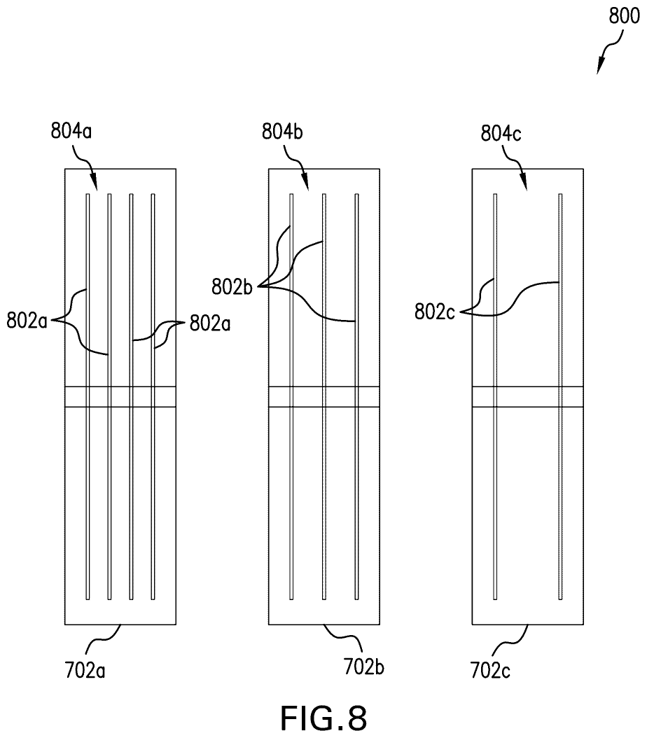

FIG. 8 shows a detailed view of the turbines of FIG. 7, in an embodiment with different gap widths. First disks 802a of the first turbine 704a are separated by a first gap 804a having a first separation distance. Second disks 802b of the second turbine 704b are separated by a second gap 804b having a second separation distance. Third disks 802c of the third turbine 704c are separated by a third gap 804c having a third separation distance.

Set forth below are some embodiments of the foregoing disclosure:
Embodiment 1. A method of determining a rheological property of a fluid. Fluid is flowed into a turbine having at least two disks that are rotatable about a rotational axis and having a gap therebetween. The fluid flows into the gap at a circumferential edge of the at least two disks to rotate the at least two disks around the rotational axis. The gap is variable. A first value of a dynamic parameter of the turbine resulting from an interaction between the at least two disks and the fluid in the gap is measured as the fluid flows from the circumferential edge towards the axis with the gap having a first gap width. A second value of the dynamic parameter is measured with the gap having a second gap width different from the first gap width. The rheological property of the fluid is determined based on the first value of the dynamic parameter and the second value of the dynamic parameter.
Embodiment 2. The method of any prior embodiment, further including measuring a fluid flow parameter of the fluid and determining the rheological property of the fluid based on the first value, the second value and the fluid flow parameter.
Embodiment 3. The method of any prior embodiment, further including determining the rheological property by performing one of: (i) comparing the fluid flow parameter and at least one of the first value and the second value to experimentally determined calibration data stored in a database; and (ii) using an experimentally determined mathematical relation.
Embodiment 4. The method of any prior embodiment, wherein the dynamic parameter of the turbine is at least one of: (i) a torque applied to the at least two disks by the fluid; and (ii) a rotational velocity of the at least two disks.
Embodiment 5. The method of any prior embodiment, wherein the fluid flow parameter is at least one of: (i) a flow rate of the fluid; (ii) a density of the fluid; (iii) a first fluid pressure at an inlet of the turbine; (iv) a second fluid pressure at an outlet of the turbine; (v) a first fluid temperature at the inlet; and (vi) a second fluid temperature at the outlet.
Embodiment 6. The method of any prior embodiment, wherein the rheological property further includes at least one of (i) a viscosity of the fluid; (ii) a shear stress of the fluid; (iii) a shear rate of the fluid; (iv) an adhesion of the fluid; and (v) a gel strength of the fluid.
Embodiment 7. The method of any prior embodiment, wherein a flow of the fluid is one of (i) Newtonian flow; and (ii) non-Newtonian flow.
Embodiment 8. The method of any prior embodiment, wherein the turbine further includes a first turbine in parallel with a second turbine, the first turbine having first disks separated by the first gap width and the second turbine having second disks separated by the second gap width, the method further including flowing the fluid into the first turbine and the second turbine.
Embodiment 9. The method of any prior embodiment, further including controlling a temperature of the fluid flowing into the turbine.
Embodiment 10. A system for measuring a rheological property of a fluid. The system includes a turbine having at least two disks rotating around a rotational axis of the turbine, the at least two disks separated by a gap that is variable, a nozzle at a circumferential edge of the at least two disks for flowing the fluid into the gap, a sensor for measuring a dynamic parameter of the turbine resulting from an interaction between the at least two disks and the fluid in the gap as the fluid flows from the circumferential edge towards the axis, and a processor. The processor is configured to determine the rheological property of the fluid based on a first value of the dynamic parameter of the turbine obtained from the sensor with the gap having a first gap width and a second value obtained from the sensor with the gap having a second gap width different from the first gap width.
Embodiment 11. The system of any prior embodiment, wherein the processor is further configured to determine the rheological property of the fluid based on the first value, the second value and a fluid flow parameter.
Embodiment 12. The method of any prior embodiment, wherein the processor is further configured to determine the rheological property by performing one of: (i) comparing the fluid flow parameter and at least one of the first value and the second value to experimentally determined calibration data stored in a database; and (ii) using an experimentally determined mathematical relation.
Embodiment 13. The method of any prior embodiment, wherein the dynamic parameter of the turbine is at least one of: (i) a torque applied to the at least two disks by the fluid; and (ii) a rotational velocity of the at least two disks.
Embodiment 14. The method of any prior embodiment, wherein the fluid flow parameter is at least one of: (i) a flow rate of the fluid; (ii) a density of the fluid; (iii) a first fluid pressure at an inlet to the turbine; (iv) a second fluid pressure at an outlet of the turbine; (v) a first fluid temperature at the inlet; and (vi) a second fluid temperature at the outlet.
Embodiment 15. The method of any prior embodiment, wherein the turbine is located at one of: (i) a surface of a drilling operation; and (iii) in a drill string.
Embodiment 16. The method of any prior embodiment, further including a first turbine in parallel with a second turbine, the first turbine having first disks separated by the first gap width and the second turbine having second disks separated by the second gap width, wherein fluid flows fluid from a turbine input line both into the first turbine and the second turbine.
Embodiment 17. The method of any prior embodiment, further including at least one of: (i) a temperature control device for controlling a temperature of the fluid flowing into the turbine; and (ii) a gap control device for controlling the gap width between the at least two disks.
Embodiment 18. The method of any prior embodiment, further including a pump configured to increase flow rate of the fluid from a zero-velocity, and wherein the processor is further configured to determine the gel strength of the fluid from a measurement of the dynamic parameter as the flow rate of the fluid increases from the zero-velocity flow rate.
Embodiment 19. A method of determining a rheological property of a fluid. The method includes flowing the fluid into a turbine having at least two disks that are rotatable about a rotational axis and having a gap therebetween, wherein the fluid flows into the gap at a circumferential edge of the at least two disks to rotate the at least two disks around the rotational axis, measuring a first value of a dynamic parameter of the turbine resulting from an interaction between the at least two disks and the fluid in the gap as the fluid flows from the circumferential edge towards the axis, wherein the fluid has a first fluid flow parameter value, measuring a second value of the dynamic parameter of the turbine resulting from an interaction between the at least two disks and the fluid in the gap as the fluid flows from the circumferential edge towards the axis, wherein the fluid has a second fluid flow parameter value, and determining the rheological property of the fluid based on the first value of the dynamic parameter and the second value of the dynamic parameter.
Embodiment 20. The method of any prior embodiment, wherein the fluid flow parameter is at least one of: (i) a flow rate of the fluid; (ii) a density of the fluid; (iii) a first fluid pressure at an inlet of the turbine; (iv) a second fluid pressure at an outlet of the turbine; (v) a first fluid temperature at the inlet; and (vi) a second fluid temperature at the outlet of the turbine.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of determining a rheological property of a fluid, comprising:
flowing the fluid into a turbine having at least two disks that are rotatable about a rotational axis and having a gap therebetween, wherein the fluid flows into the gap at a circumferential edge of the at least two disks to rotate the at least two disks around the rotational axis, wherein the gap is variable;
measuring a first value of a dynamic parameter of the turbine resulting from an interaction between the at least two disks and the fluid in the gap as the fluid flows from the circumferential edge towards the axis with the gap having a first gap width;
measuring a second value of the dynamic parameter with the gap having a second gap width different from the first gap width; and
determining the rheological property of the fluid based on the first value of the dynamic parameter and the second value of the dynamic parameter.

2. The method of claim 1, further comprising measuring a fluid flow parameter of the fluid and determining the rheological property of the fluid based on the first value, the second value and the fluid flow parameter.

3. The method of claim 2, further comprising determining the rheological property by performing one of: (i) comparing the fluid flow parameter and at least one of the first value and the second value to experimentally determined calibration data stored in a database; and (ii) using an experimentally determined mathematical relation.

4. The method of claim 2, wherein the dynamic parameter of the turbine is at least one of: (i) a torque applied to the at least two disks by the fluid; and (ii) a rotational velocity of the at least two disks.

5. The method of claim 4, wherein the fluid flow parameter is at least one of: (i) a flow rate of the fluid; (ii) a density of the fluid; (iii) a first fluid pressure at an inlet of the turbine; (iv) a second fluid pressure at an outlet of the turbine; (v) a first fluid temperature at the inlet; and (vi) a second fluid temperature at the outlet.

6. The method of claim 1, wherein the rheological property further comprises at least one of (i) a viscosity of the fluid; (ii) a shear stress of the fluid; (iii) a shear rate of the fluid; (iv) an adhesion of the fluid; and (v) a gel strength of the fluid.

7. The method of claim 1, wherein a flow of the fluid is one of (i) Newtonian flow; and (ii) non-Newtonian flow.

8. The method of claim 1, wherein the turbine further comprises a first turbine in parallel with a second turbine, the first turbine having first disks separated by the first gap width and the second turbine having second disks separated by the second gap width, the method further comprising flowing the fluid into the first turbine and the second turbine.

9. The method of claim 1, further comprising controlling a temperature of the fluid flowing into the turbine.

10. A system for measuring a rheological property of a fluid, comprising:
a turbine having at least two disks rotating around a rotational axis of the turbine, the at least two disks separated by a gap that is variable;
a nozzle at a circumferential edge of the at least two disks for flowing the fluid into the gap;
a sensor for measuring a dynamic parameter of the turbine resulting from an interaction between the at least two disks and the fluid in the gap as the fluid flows from the circumferential edge towards the axis; and
a processor configured to:
determine the rheological property of the fluid based on a first value of the dynamic parameter of the turbine obtained from the sensor with the gap having a first gap width and a second value obtained from the sensor with the gap having a second gap width different from the first gap width.

11. The system of claim 10, wherein the processor is further configured to determine the rheological property of the fluid based on the first value, the second value and a fluid flow parameter.

12. The system of claim 11, wherein the processor is further configured to determine the rheological property by performing one of: (i) comparing the fluid flow parameter and at least one of the first value and the second value to experimentally determined calibration data stored in a database; and (ii) using an experimentally determined mathematical relation.

13. The system of claim 11, wherein the dynamic parameter of the turbine is at least one of: (i) a torque applied to the at least two disks by the fluid; and (ii) a rotational velocity of the at least two disks.

14. The system of claim 13, wherein the fluid flow parameter is at least one of: (i) a flow rate of the fluid; (ii) a density of the fluid; (iii) a first fluid pressure at an inlet to the turbine; (iv) a second fluid pressure at an outlet of the turbine; (v) a first fluid temperature at the inlet; and (vi) a second fluid temperature at the outlet.

15. The system of claim 10, wherein the turbine is located at one of: (i) a surface of a drilling operation; and (iii) in a drill string.

16. The system of claim 10, further comprising a first turbine in parallel with a second turbine, the first turbine having first disks separated by the first gap width and the second turbine having second disks separated by the second gap width, wherein fluid flows from a turbine input line both into the first turbine and the second turbine.

17. The system of claim 10, further comprising at least one of: (i) a temperature control device for controlling a temperature of the fluid flowing into the turbine; and (ii) a gap control device for controlling the gap width between the at least two disks.

18. The system of claim 10, further comprising a pump configured to increase flow rate of the fluid from a zero-velocity, and wherein the processor is further configured to determine the gel strength of the fluid from a measurement of the dynamic parameter as the flow rate of the fluid increases from the zero-velocity flow rate.

19. A method of determining a rheological property of a fluid, comprising:
flowing the fluid into a turbine having at least two disks that are rotatable about a rotational axis and having a gap therebetween, wherein the fluid flows into the gap at a circumferential edge of the at least two disks to rotate the at least two disks around the rotational axis;
measuring a first value of a dynamic parameter of the turbine resulting from an interaction between the at least two disks and the fluid in the gap as the fluid flows from the circumferential edge towards the axis, wherein the fluid has a first fluid flow parameter value;
measuring a second value of the dynamic parameter of the turbine resulting from the interaction between the at least two disks and the fluid in the gap as the fluid flows from the circumferential edge towards the axis, wherein the fluid has a second fluid flow parameter value; and
determining the rheological property of the fluid based on the first value of the dynamic parameter and the second value of the dynamic parameter.

20. The method of claim 19, wherein the fluid flow parameter is at least one of: (i) a flow rate of the fluid; (ii) a density of the fluid; (iii) a first fluid pressure at an inlet of the turbine; (iv) a second fluid pressure at an outlet of the turbine; (v) a first fluid temperature at the inlet; and (vi) a second fluid temperature at the outlet of the turbine.
